(19) United States
(12) Patent Application Publication
(10) Pub. No.: US 2013/0124602 A1
(43) Pub. Date: May 16, 2013

(54) Handling Asynchronous Responses From Servers

(71) Applicant: Daniel W. Miley, Palo Alto, CA (US)

(72) Inventor: Daniel W. Miley, Palo Alto, CA (US)

(21) Appl. No.: 12/200,700

(22) Filed: Aug. 28, 2008

(51) Int. Cl. G06F 15/173

(52) U.S. Cl. 709/203

(57) ABSTRACT

Various embodiments of a method and system for handling asynchronous responses from servers. A network-enabled application (e.g., web browser) may have a client-side component (e.g., browser plug-in) for providing services “on-demand” to client code (e.g., JavaScript). The client code may use the client-side component for sending network requests of the same type to a network server. The client code may have a response function associated with each network request, such that when the client-side component receives a response, it routes the response to the response function associated with the original network request. The client code may send two or more requests of the same type to the network server in a short period of time. The network server may return responses asynchronously, in an undetermined order. The client-side component may receive all responses and route each to the respective response function in the client code associated with the initial request.

### BACKGROUND

Web applications are applications accessed via a web browser over a network such as the Internet or an Intranet. A web application may be coded in a browser-supported language such as Hyper Text Markup Language (HTML), and a scripting language such as JavaScript™, ActionScript™ or a similar language. Web applications are typically dependent on a web browser to render the application and present the user interface.

Though many variations are possible, a web application is commonly structured as a three-tiered application. In one form, a web browser is the first tier, an engine using dynamic web content technology (e.g., ASP™, ASP.NET™, CGI, JSP/Java™, PHP) is the middle tier, and a database is the third tier. A web browser sends a request to the middle tier, which services the request and may query and/or update a database. Subsequently, the middle tier returns a response to the web browser.

Rich Internet Applications (RIAs) are web applications that have the features and functionality of traditional desktop applications. RIAs may use a plug-in, such as Adobe Flash™ or Java applets, to provide the programmer greater control over the user interface and bypass many browser-configuration issues. Further, RIAs provide a framework that allows some of the business logic that takes place on the server to be moved to the client.

### SUMMARY

Various embodiments of methods and systems of handling asynchronous responses from servers are disclosed. A network-enabled application (e.g., web browser) may have a client-side component (e.g., browser plug-in) and client code (e.g., hypertext markup language and a scripting language, such as JavaScript). The client-side component may provide services to the client code, such as routing network requests to a network server. The client-side component may receive two or more network requests with the same application type code from the client code. Each network request may correspond to a response function in the client code, designated to handle the response from the server.

The client-side component may forward the two or more network requests to a network server (e.g., web server). The network-server may process the network requests and return responses to the network-enabled application, which may forward the responses to the client-side component. Subsequently, the client-side component may receive the two or more responses from the network server, each response corresponding to a respective request. The client-side component may forward each response to the corresponding response function in the client code.

### BRIEF DESCRIPTION OF THE DRAWINGS

FIG. 1 is a block diagram illustrating a method and system for handling asynchronous responses from servers, according to some embodiments.

FIG. 2 is a flow diagram illustrating a client-side component to sending requests to a server and receiving responses from the server, according to some embodiments.

FIG. 3 is a block diagram illustrating a network client, according to some embodiments.

FIG. 3 is a flow diagram illustrating client code making network requests to a network server, according to some embodiments.

FIG. 4 is a flow diagram of a server component preparing to send a network request, according to some embodiments.

FIG. 6 is a sequence diagram illustrating a method and system for handling asynchronous responses from servers, according to some embodiments.

FIG. 7 is a block diagram illustrating a system for implementing an application component for handling asynchronous responses from servers, according to some embodiments.

While the system is described herein by way of example for several embodiments and illustrative drawings, those skilled in the art will recognize that the system is not limited to the embodiments or drawings described. It should be understood, that the drawings and detailed description thereto are not intended to limit the system to the particular form disclosed but on the contrary, the intention is to cover all modifications, equivalents and alternatives falling within the spirit and scope of the present system as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words, “include”, “including”, and “includes” mean including, but not limiting to.

### DETAILED DESCRIPTION OF EMBODIMENTS

### Introduction

As described above, the general configuration of a web-based application includes a network-enabled application (e.g., web browser). The network-enabled application may host a web application. The web application (hereafter referred to as “Client Code”) may be coded in hypertext markup language (HTML) and a scripting language, such as JavaScript™, or ActionScript™. The network-enabled application may host a client-side component (e.g., plug-in, such as Adobe Flash Player™) configured to provide certain functions to the client code “on demand”.

The client-side component may provide an application programming interface (API) to the client code. The client code may call on the client-side component to create a server object. The server object may provide the client code a programming interface to a network server, such that the client code sends network requests to the server object as if the server object were the network server.

The client code may send a network request to the server object and specify desired application response logic be invoked (e.g., in the client code) when the response returns from the network server. The network server may receive the network request, process the request and return a response to the server object. The server object may then route the response to the desired application response logic (e.g., to a client code function) in the client code.

In one embodiment, the server object provides a technique for the client code to make a hypertext transfer protocol (HTTP) GET or POST request, specify optional http headers, specify a Uniform Resource Identifier (URI) for the network server, specify an optional HTTP body, specify an application type code for the request and specify a response function to be invoked when the response returns from the server. An application type code can be defined as any code, character string or numeric value that designates a type of network request. One or more network requests may share the same application type code.

The server object may create and use a URL Loader object to make the network request (with all the given input described above) and track the response that eventually comes back from the server. The URL Loader object is further configured to map the network response to a category of network completion states (e.g., “Success”, “I/O error”, Security Error, etc.). Several responses with the same application type code may return to the client-side component asynchronously, in an order different than the order in which they were sent. The client-side component is configured to route each of the multiple responses with the same completion state and the same application type code to the correct application response logic (e.g., client code response function), such that each response may be routed to a separate response function in the client code.

In the preferred embodiment, each network request/response corresponds to a separate response function in the client code, whereby each network response with the same application type code is routed to a different response function in the client code.

### System Overview

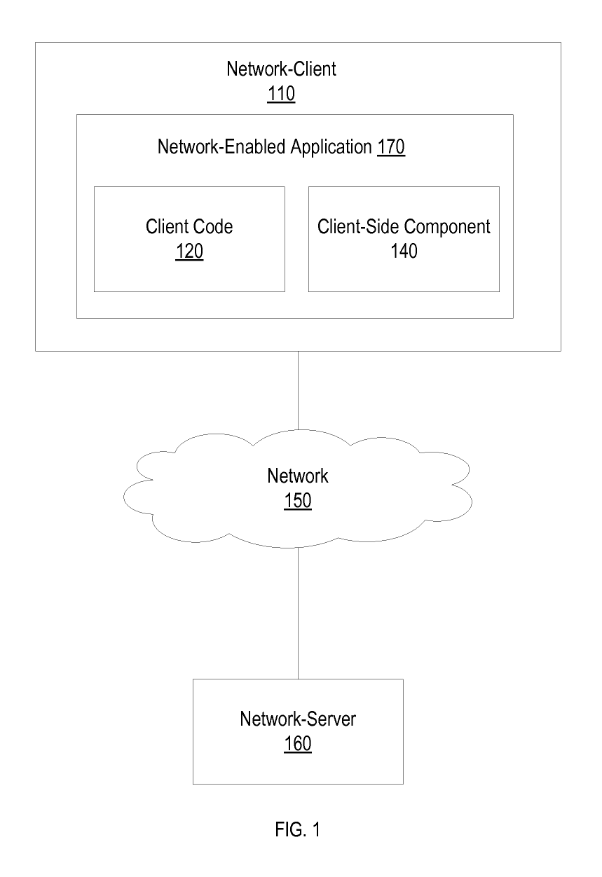

FIG. 1 is a block diagram illustrating a method and system for handling asynchronous responses from servers, according to some embodiments. Network-client 110 may be implemented as any computing device configured to execute program instructions and connect to a network, such as network 150. Network-client 110 may be implemented a desktop computer, laptop, server, cell phone, personal digital assistant, or another suitable computing device. Network-client 110 may be configured with an operating system. The operating system may be configured to interact with network-enabled application 170 in order to manage resources such as managing files and communicating with other computing devices (e.g., network-based server 160) via network 150. Example operating system implementations include Linux, Mac OS X™, Microsoft Windows™, and Solaris™.

Network-enabled application 170 may be implemented as a software application, enabling a user to display and interact with text, images, videos, music and other information. Network-enabled application 170 may be implemented as a web browser or another application configured to communicate via network 150, as well as send requests and receive responses from network-server 160. Example web browser implementations include Internet Explorer™, Firefox™, Safari™ and Opera™. Network-enabled application 170 may be configured to format HTML information for display as web pages and communicate with network-server 160 via a network protocol such as HTTP or another suitable protocol.

Network-enabled application 170 may be configured to execute client code 120. Client code 120 may be implemented in one or more scripting languages, such as a scripting language used for client-side web development. Client code 120 may be interpreted by network-enabled application 170. Client code 120 may be embedded in a web page and may include HTML and a scripting language, such as JavaScript™ or ActionScript™. Client code 120 may be configured to communicate with client-side component 140 by use of an API.

Network-enabled application 170 may be configured to host one or more client-side components 140; each client-side component 140 may extend the functionality of network-enabled application 170. Client-side component 140 may be implemented as one or more computer programs or libraries that interact with network-enabled application 170 and client code 120. Client-side component 140 may provide certain functions “on demand” to extend the features of network-enabled application 170. Client-side component 140 may be downloaded from a server (e.g., network-server 160) via network 150 or installed from storage media (e.g., CD or DVD). When installed, client-side component 140 may register itself with network-enabled application 170 and provide a protocol for exchanging data with network-enabled application 170. Client-side component 140 may provide an API, allowing client code 120 to make calls, pass information and receive information back from client-side component 140. Client-side component 140 may be configured to communicate with network-server 160 via network 150. Client-side component 140 may be implemented as a component of a web browser, a browser plug-in or an ActiveX™ component. For example, one implementation of client-side component 140 may be Adobe Flash™.

In various embodiments, network 150 may be configured to allow data to be exchanged between network-client 110 and other devices connected to network 150, such as network server 160. Network 150 may correspond to various methods of communication between entities and may include, but is not limited to communication via the Internet, telephone, fax, email, messages (e.g., instant messaging), voice messages, and electronic documents (e.g., web page, email or file transfers). In general, network 150 may represent any method that one entity may utilize to communicate with another entity. While network 150 may be illustrated in a generalized manner, one of ordinary skill in the art will recognize that network 150 is meant to be representative of a complete communication path between the entities depicted in FIG. 1 with a specific type of communication channel. For example, network 150 may represent one or more communications channels and may include one or more telecommunications networks as well as various data networks. Network 150 may include network devices such as circuits, switches, routers, hubs and/or gateways. Network 150 may support communication via wired or wireless general data networks, such as any suitable type of network including the Internet and/or Ethernet LAN; via telecommunications/telephony networks such as analog voice networks or digital fiber communications networks; via storage area networks such as Fiber Channel SANs, or via any other suitable type of network and/or protocol. Data may be transmitted on network 150 using Hyper Text Transport Protocol (HTTP), Secure Hyper Text Transport Protocol (HTTPS), Secure Socket Layer Protocol (SSL), Transport Layer Security Protocol (TLS) or another suitable network transport protocol. In various embodiments, the services described herein may utilize any suitable compression protocol or cryptographic protocol when communicating over network 150.

Network-server 160 may be implemented as any computing system configured to connect to network 150 and communicate with network-client 110. In some embodiments, network-server 160 is implemented as a web server. Network-server 160 may service requests from one or more network-clients 110. Network-server 160 may be configured to listen on a port (e.g., port 80) waiting for network-client 110 to send a request message, such as for an image file stored in a data store. When network-server 160 receives a request, it may be configured to fetch content (e.g., web content or image file) and forward the content to network-client 110. Network-server 160 may be implemented as one or more physical systems connected to one or more storage devices. Network-server 160 may be configured to run special web server software to service client system requests. Example web server software includes Microsoft™ Internet Information Systems™ and Apache™. Other server host application software is possible. In some embodiments, network-server 160 may provide web services or be implemented as an application server.

In one example of how the web application on network client 110 and the network-server 160 may interact, the client code 120 may request the client-side component 140 create a server object. The client code 120 may invoke one or more methods of the client-side component 140 to forward two or more network requests of the same type to the network-server 160. The client-side component 140 may forward the requests via (HTTP) to the network server 160 in a very short sequence of time. The network-server 160 may receive the network requests, service the requests and return responses. The client-side component 120 may not receive responses from the network-server in the order in which they were sent. In fact, the nature of the HTTP request/response protocol implies that responses are not guaranteed to be in order. The client code may be configured with separate blocks of code, each corresponding to a specific network request/response. Each block of code may be accessed by a specific function. When the responses arrive asynchronously in an undetermined order with the same application type code and completion state (e.g., “Success”), it may be difficult to determine where (i.e., which client code function) to route the response. The remainder of this document describes methods and systems for routing asynchronous responses of the same type from a network-server to the correct functions (i.e., within client code) designated for handling the responses.

### Client-Side Component Workflow

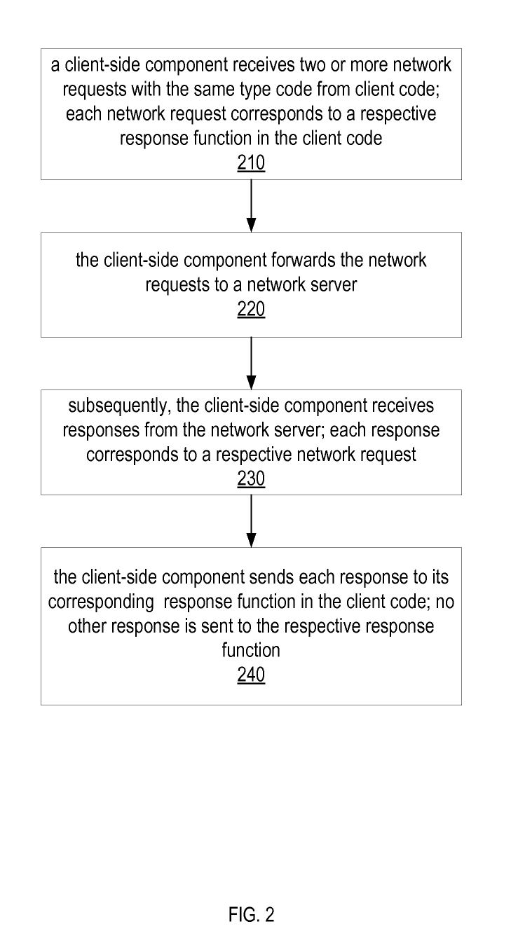

FIG. 2 is a flow diagram illustrating a client-side component sending requests to a server and receiving responses from the server, according to some embodiments. As shown in block 210, client-side component 140 may receive two or more network requests with the same application type code from client code 120. The requests may be network requests for information located on network-server 160. In some embodiments, the requests may be received when client code 120 makes an API call to client-side component 140.

In one example, client code 120 may request several images located on network-server 160. Each network request made by client code 120 may correspond to a respective response function in client code 120; each function designated to handle a specific network response. When each request is made, the request includes at least a application type code and a reference to a response function in client code 120, which is be executed when the response corresponding to a specific request is received back from network server 160.

As shown in block 220, client-side component 140 forwards each request to network server 160. In some embodiments the network request may be sent via an HTTP POST or GET. Network server 160 may receive each network request, process each request and returns a response. Subsequently, client-side component 140 receives each response from network server 160 as shown in block 230. Each response corresponds to a respective network request. The responses may be received in an order different from the order in which the requests were made. The client-side component may forward each response to its corresponding response function in the client code, as shown in block 240. Client-side component 140 does not send any other information to the designated response function.

### Network-Enabled Application

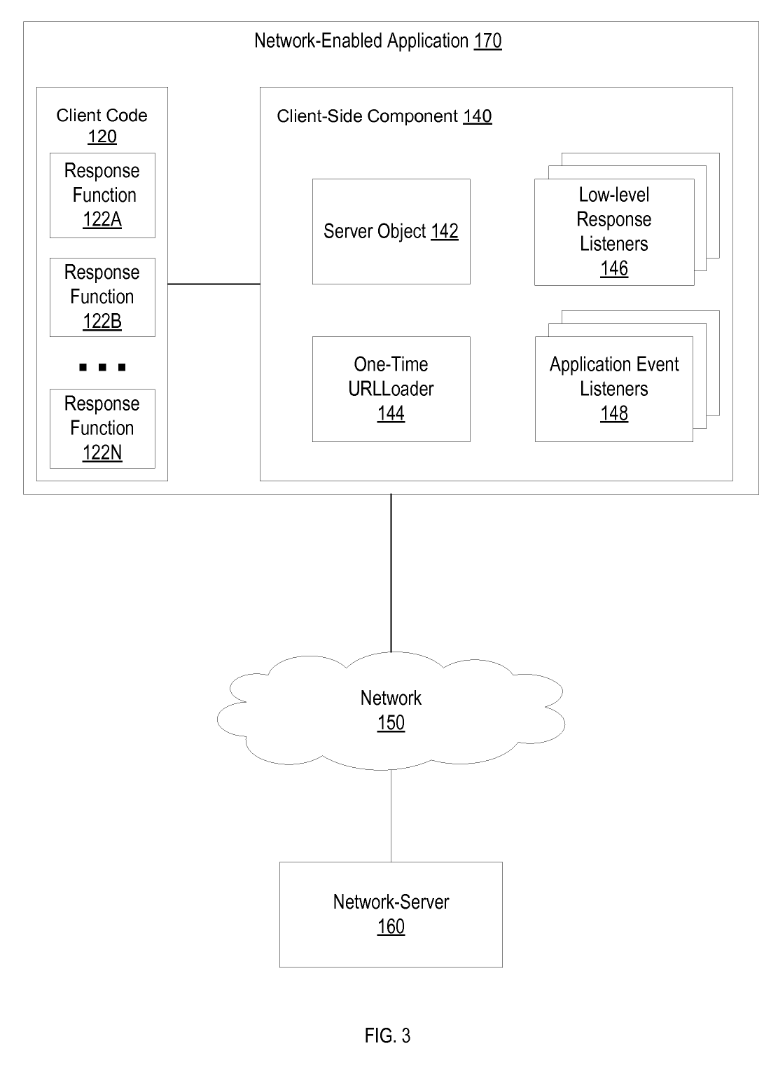

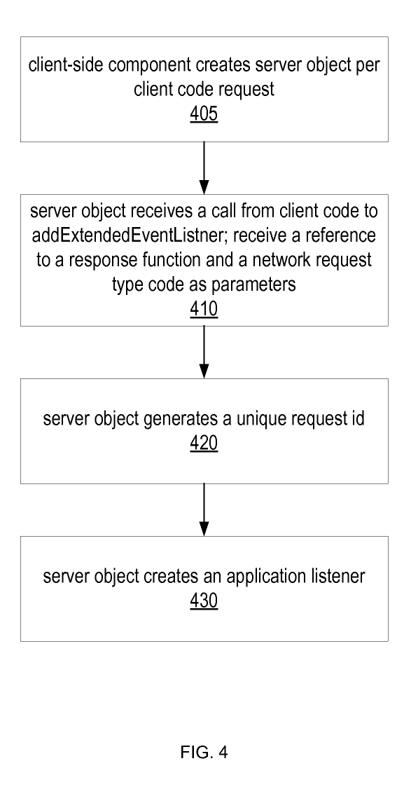

FIG. 3 is a block diagram illustrating client code and a client-side component, both hosted by a network-based application, according to some embodiments. As described above, network-enabled application 170 (e.g., a web browser) may host client code 120 (e.g., JavaScript™ or another scripting language) and client-side component 140 (e.g., a browser plug-in component that provides services on-demand to client code 120).

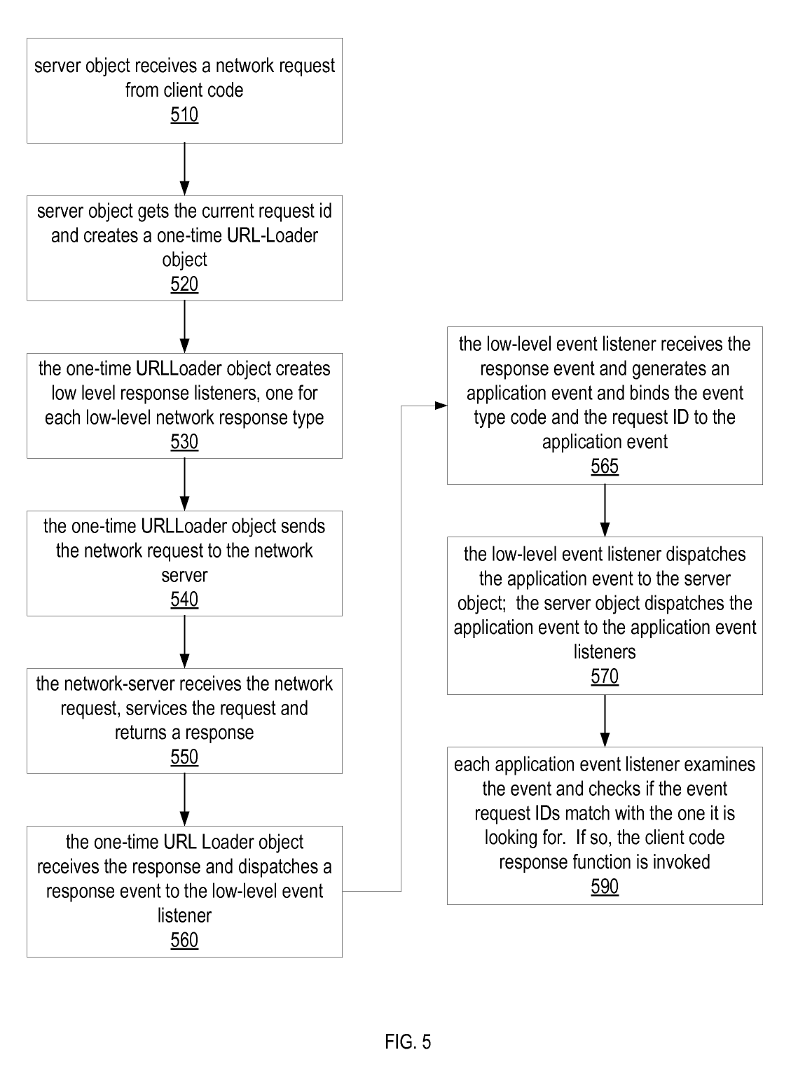

A response function 122 may be implemented as a block of code that is invoked when a response to a network request comes back from network-server 160. A particular response function 122 may be associated with a particular network request/response. When the response is received the particular response function 122 that is associated with the request/response may be invoked. (See the description of FIG. 4 and FIG. 5 for a more detailed description of how a response function is associated with a network request/response.)

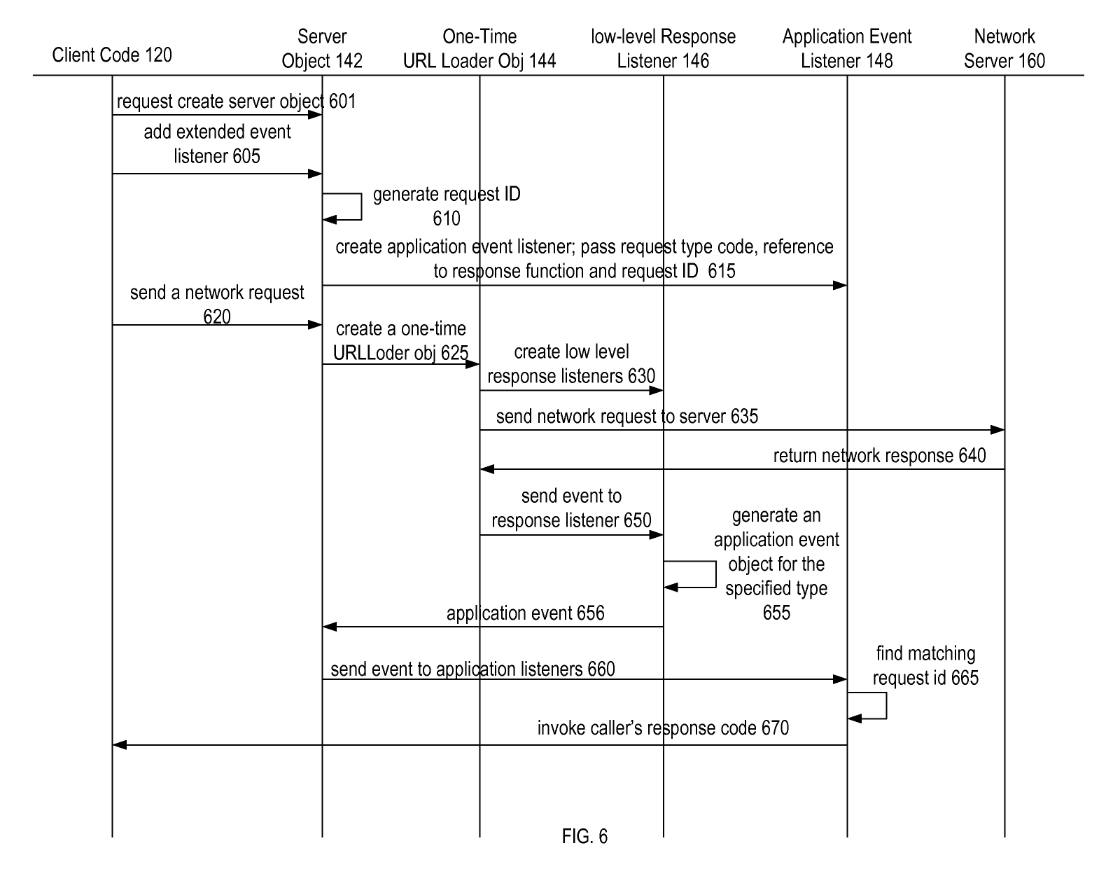

Server object 142 is created by client-side component 140 at the request of client code 120. Server object 142 may serve as an interface between client code 120 and network server 160, whereby network requests are routed through server object 142. Client code 120 may invoke the server object method addExtendedEventListener( ) on the server object, and in response, the server object may create an application object to listen for responses from the server that correspond to a particular network request. (See the description of FIG. 5 and FIG. 6 for a more detailed description of the server object 142.)

One-time URL Loader 144 may be created by server object 142 and used by server object 142 for sending network requests and receiving responses. One-time URL Loader 144 is created for a specific network request/response and is used only once. In other words, a URL Loader 144 is created for one network request/response and is destroyed after the response is handled. When URL Loader 144 sends a network request to a network server, if the response is returned, the response is routed to the URL Loader 144 that sent the request. One-time URL Loader routes responses to low-level response listeners 146. (See the description of FIG. 5 and FIG. 6 for a more detailed description of one-time URL Loader 144.)

Low-level response listeners 146 are created by URL Loader 144. Low-level response listeners 146 may be implemented as closure objects. A separate low-level response listener 146 may be created for each possible response type and/or completion state. For example, a low-level response listener 146 may be created for each of (1) success response, (2) security error, (3) timeout error, and (4) any additional error. Each low-level response listener 146 is configured to handle a specific type of response. Low-level response listener 146 may generate an application event object, used to wrap the network response. In addition, low-level response listener 146 may bind the request ID and the application type code to the application event object.

Application event listener 148 may be created by server object 142. Application event listener 148 listens for an event with the application type code received from client-code 120 via the addExtendedEventListener( ) method. Application event listener 148 may be implemented as a closure function that looks at the request ID in the incoming response and compares it to the request ID created by the server object for the request/response. If they match, then the response function 122 that corresponds to the initial network request is invoked. (See the discussion of FIG. 5 and FIG. 6 for a more detailed description.)

### Preparing to Send a Network Request

FIG. 4 is a flow diagram of a server component preparing to send a network request, according to some embodiments. The flow shown in FIG. 4 is performed in preparation to sending a network request. (See the description of FIG. 5 for a discussion of sending the network request.) Client code 120 initially requests client-side component 140 create a server object (e.g., server object 142) and in response, client-side component 140 creates server object 142. Server object 142 serves as the interface object between client code 120 and network-server 160, such that client code 120 invokes various methods of server object 142 to send the network request and receive the network response.

As shown in block 410, client code 120 may initially invoke the server object method addExtendedEventListener( ) for each network request and pass at least the arguments of a reference to a response function, and an application type code (e.g., event type). Below is an example prototype of the addExtendedEventListener( ) method, according to one embodiment. (Other embodiments may include other method names and other arguments.)

```
addExtendedEventListener( ) method
public function addExtendedEventListener(eventType:String,
    onRequestIdMatchFunction:Function,
    useCapture:Boolean = false,
    priority:int = 0,
    useWeakReference:Boolean = false):voidParameters
    eventType:String
    onRequestIdMatchFunction:Function
    useCapture:Boolean(default=false)
    priority:int(default=0)
    useWeakReference:Boolean(default=false)
```

As shown in block 420, in response to receiving the addExtendedEventListener( ) call, server object 142 may generate a unique request ID. The unique request ID corresponds to a particular network request/response and may be used to verify a particular response is associated with a particular request.

As shown in block 430, further in response to the addExtendedEventListener( ) call, server object 142 may create an application listener 148. When a network response arrives, application listener 148 verifies the response has the correct request ID and invokes the correct response function 122.

### Sending a Network Request and Receiving a Response

FIG. 5 is a flow diagram illustrating an application component sending a network request to a server and receiving a response, according to some embodiments. The description of FIG. 5, as well as the object names and data flows are described as an example of one embodiment. Other flows may be implemented in other embodiments. The flow described in FIG. 5 may take place subsequent to preparing to send a network request (e.g., the flow described in FIG. 4).

As shown in block 510, server object 142 may receive a network request from client code 120. As shown in block 520, the server object retrieves the previously generated request ID. (The request ID was previously generated when addExtendedEventListener( ) was invoked; see FIG. 4) One-time URL Loader 144 is created at this time by server object 142. As shown in block 530, one-time URL Loader 144 creates low-level response listeners 146. One low-level response listener is created for each possible response completion state (e.g., success, error, etc.).

As shown in block 540, one-time URL Loader 144 sends the network request to network-server 160. Network-server 160 receives the network request, processes the request and returns a response as shown in block 550.

One-time URL Loader 144 may receive the response, as shown in block 560. A response event object is dispatched to the appropriate low-level response listener 146. If the event type indicates “Success”, the event object is dispatched to the low-level response listener 146 designated to handle “Success” responses (as opposed, for example, to one of the low-level response listeners designated to handle error responses).

As shown in block 565, the low-level response listener 146 generates an application event object and binds the application event object to the application type code and the request ID.

As shown in block 570, the low-level response listener 146 dispatches the application event object to server object 142, which then routes the application event object to the application event listeners 148.

As shown in block 590, each application event listener may examine the event. Each application event listener 148 is associated with a request ID and a network request application type code. Each application event listener 148 may examine the application event and compare the request ID and the network request application type code in the application event to the request ID and network request application type code associated with the application listener 148. If there is a match, application listener 148 may dispatch the application event to the appropriate response function 122.

### Request/Response Sequence

FIG. 6 is a sequence diagram illustrating a method and system for handling asynchronous responses from servers, according to some embodiments. As shown at element 601, client code 120 may request client-side component 140 create server object 142, and in response, client side component 140 creates the server object. As shown at element 605, client code 120 may call the addExtendedEventListener( ) method and pass a reference to the response function 122 (in client code 120) and the network request application type code as arguments. In response, as shown at element 610, server object 142 may generate a unique request ID. As shown at element 615, server object 142 may create an application event listener and pass it the request application type code, the reference to the response function and the request ID as arguments.

As shown at element 620, after calling the addExtendedEventListener( ) method, client code 120 may invoke a method of server object 142 to send a network request. In response, as shown at element 625, server object 142 may create a one-time URL Loader object 144. As shown at element 630, one-time URL Loader object 144 may create low-level response listeners 146. As described above, one low-level response listener 146 may be created for each possible response type (e.g., success, error, etc.).

As shown at element 635, one-time URL Loader object 144 may send the network request to network server 160. As shown at block 640, network server 160 may service the request and return a response.

After receiving the response, if the response indicates “Success”, one-time URL Loader object 144 may send the response to low-level response listener 146 designated to handle “Success” responses. Low-level response listener 146 may generate an application event object as shown at item 655. The application event object may wrap the network response. Low-level response listener 146 may bind the request ID and the application type code to the application event object and send the application event object to server object 142, as shown at item 656. Server object 142 may send the application event to application event listener 148 as shown at item 660. There may be one or more application event listeners 148 listening for events of the same type. Each application event listener 148 may determine if the request ID and application type code in the event matches the request ID and application type code associated with the application event listener 148, as shown at element 665. If there is a match, application event listener 148 may invoke the response function in client code 120 as shown at element 670.

### Computing Device Description

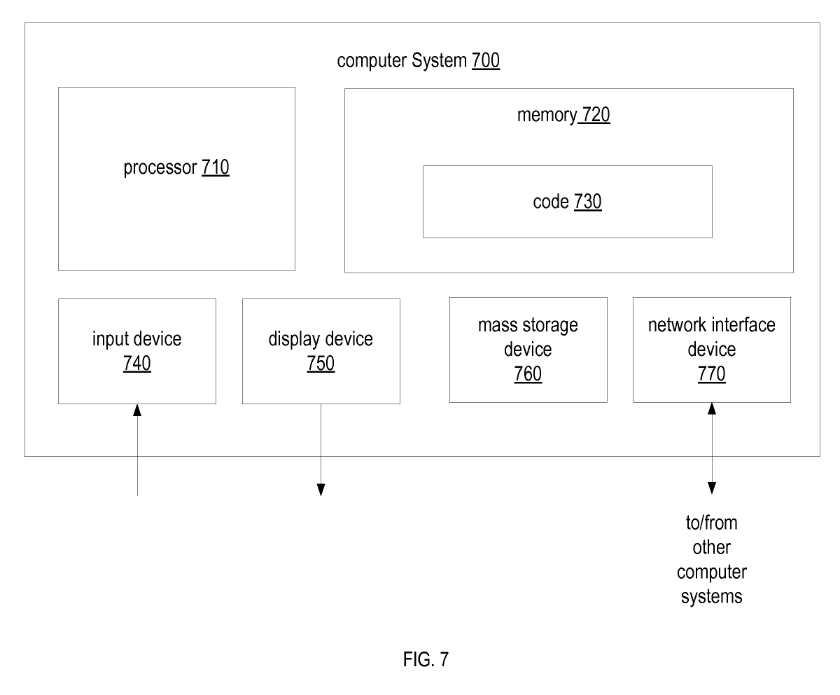

FIG. 7 is a block diagram illustrating a computing device, according to some embodiments. Various components of embodiments of network-client 110 and nodes, etc., as described herein, may be executed on one or more computer systems, which may interact with various other devices. One such computer system is illustrated by FIG. 7. In the illustrated embodiment, computer system 700 includes one or more processors 710 coupled to a system memory 720. Computer system 700 further includes a network interface 570 and one or more input/output devices 740/750, such as a cursor control device, keyboard, audio device and display device 750. In some embodiments, it is contemplated that embodiments may be implemented using a single instance of computer system 700, while in other embodiments multiple such systems, or multiple nodes making up computer system 700, may be configured to host different portions or instances of embodiments. For example, in one embodiment some elements may be implemented via one or more nodes of computer system 700 that are distinct from those nodes implementing other elements.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments, processors 710 may be general-purpose or embedded processors implementing any of a variety of instruction set architectures (ISAs), such as the x86, PowerPC, Scalable Processor Architecture (SPARC), or Million Instructions per Second (MIPS) Instruction Set Architectures (ISAs), or any other suitable ISA. In multiprocessor systems, each of processors 510 may commonly, but not necessarily, implement the same ISA.

System memory 720 may be configured to store program instructions 730 and/or data accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. Program instructions and/or data may also be stored, for example, on a hard disk. In the illustrated embodiment, program instructions and data implementing desired functions, such as those described above for client-side component 140, are shown stored within system memory 720 as program instructions 730 and data storage 760, respectively. In other embodiments, program instructions and/or data may be received, sent or stored upon different types of computer-accessible media or on similar media separate from system memory 720 or computer system 700. Generally speaking, a computer-accessible medium may include storage media or memory media such as magnetic or optical media, e.g., disk or Digital Versatile Disc (DVD) Read Only Memory (ROM)/Compact Disk-Read Only Memory (CD-ROM) coupled to computer system 700. Program instructions and data stored via a computer-accessible medium may be transmitted by transmission media or signals such as electrical, electromagnetic, or digital signals, which may be provided via a communication medium such as a network and/or a wireless link, such as may be implemented via network interface 770.

Network interface 770 may be configured to allow data to be exchanged between computer system 700 and other devices attached to a network, such as other computer systems, or between nodes of computer system 700. In various embodiments, network interface 770 may support communication via wired or wireless general data networks, such as any suitable type of Ethernet network, for example; via telecommunications/telephony networks such as analog voice networks or digital fiber communications networks; via storage area networks such as Fibre Channel Storage Area Networks (SANs), or via any other suitable type of network and/or protocol.

Input/output devices 740 and 750 respectively, may in some embodiments include one or more display terminals, keyboards, keypads, touchpads, scanning devices, voice or optical recognition devices, or any other devices suitable for entering or retrieving data by one or more computer system 700. Multiple input/output devices 740 and 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 770.

Memory 720 may include program instructions 730, configured to implement at least a portion of embodiments of the client-side component 140 as described herein, and data storage 760, comprising various documents, tables, databases, etc. accessible by program instructions 730. In one embodiment, program instructions 730 may include software elements of client-side component 140 illustrated in the Figures, and data storage 760 may include data used in embodiments of client-side component 140. In other embodiments, different software elements and data may be included. Program instructions and/or data may be stored, for example, on various types of memory including hard disks.

Those skilled in the art will appreciate that computer system 700 is merely illustrative and is not intended to limit the scope of network-client 110 and as described herein. In particular, the computer system and devices may include any combination of hardware or software that can perform the indicated functions, including computers, network devices, internet appliances, PDAs, mobile phones, pagers, etc. Computer system 700 may also be connected to other devices that are not illustrated, or instead may operate as a stand-alone system. In addition, the functionality provided by the illustrated network-client 110 may in some embodiments be combined in fewer image-editing components or distributed in additional image-editing components. Similarly, in some embodiments, the functionality of some of the illustrated client-side component 140 may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of client-side component 140 may execute in memory on another device and communicate with the illustrated computer system via inter-computer communication. Some or all of client-side component 140 or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, provided via a communication medium such as a network and/or a wireless link. Various embodiments may further include receiving, sending or storing instructions and/or data implemented in accordance with the foregoing description upon a computer-accessible medium. Accordingly, embodiments may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. Synchronous Dynamic RAM (SDRAM), Double Data Rate RAM (DDR RAM), RAMBUS Dynamic RAM (RDRAM), Static RAM (SRAM), etc.), Read Only Memory (ROM), etc. as well as transmission media or signals such as electrical, electromagnetic, or digital signals, provided via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that embodiments embrace all such modifications and changes and, accordingly, the above description to be regarded in an illustrative rather than a restrictive sense.

1. A computer-implemented method performed by a client-side component, comprising:
the client-side component receiving, from client code, a plurality of network requests each corresponding to a respective unique response function in the client code, and in response, creating a respective application event listener for each network request of the plurality of network requests;
the client-side component assigning a unique request ID to each of the plurality of network requests and to the corresponding application event listener for each request, wherein the plurality of network requests are forwarded to a network server;
the client-side component receiving a plurality of responses corresponding to the network requests, wherein the plurality of responses are not guaranteed to be received in a same order that the plurality of network requests were sent; and
in response to receiving the plurality of responses, the client-side component routing each response of the plurality of responses to one or more of the plurality of application event listeners, wherein for each response one or more of the plurality of application event listeners performs a comparison between a request ID for the response and the unique request ID associated with the application event listener, wherein if the comparison results in a match, the application event listener sends the response to the respective response function in the client code corresponding to the application event listener.

2. The method of claim 1, wherein the client-side component and the client code are hosted by a network-enabled application.

3. The method of claim 2, wherein said network-enabled application comprises a web browser.

4. The method of claim 3, wherein said client-side component comprises a browser plug-in.

5. The method of claim 1, wherein said network request comprises a hypertext transfer protocol (HTTP) request.

6. The method of claim 1, further comprising:
the client-side component creating a separate URL Loader object for each network request;
the client-side component associating each respective URL Loader object with the unique request ID for the corresponding network request;
each URL Loader object receiving the response associated with its respective network request and inserting the request ID in the response associated with the respective network request prior to the response being routed to the one or more application event listeners.

7. The method of claim 1, wherein each network request of the plurality of network requests and corresponding response has an application type code;
wherein each response of the plurality of responses is routed to the application event listeners based on the application type code; and
wherein at least some of the responses of the plurality of responses have the same application type code.

8. A system, comprising:
at least one processor; and
memory storing program instructions executable by the at least one processor to implement a client-side component:
receiving, from client code, a plurality of network requests each corresponding to a respective unique response function in the client code, and in response, creating a respective application event listener for each network request of the plurality of network requests;
assigning a unique request ID to each of the plurality of network requests and to the corresponding application event listener for each request, wherein the plurality of network requests are forwarded to a network server;
receiving a plurality of responses corresponding to the network requests, wherein the plurality of responses are not guaranteed to be received in a same order that the plurality of network requests were sent; and
the client-side component routing each response of the plurality of responses to one or more of the plurality of application event listeners, wherein for each response one or more of the plurality of application event listeners performs a comparison between a request ID for the response and the unique request ID associated with the application event listener, wherein if the comparison results in a match, the application event listener sends the response to the respective response function in the client code corresponding to the application event listener.

9. The system of claim 8, wherein the client-side component and the client code are hosted by a network-enabled application.

10. The system of claim 9, wherein said network-enabled application comprises a web browser.

11. The system of claim 10, wherein said client-side component comprises a browser plug-in.

12. The system of claim 8, wherein said network request comprises a hypertext transfer protocol (HTTP) request.

13. The system of claim 8, wherein the program instructions are further executable to implement:
the client-side component creating a separate URL Loader object for each network request;
the client-side component associating each respective URL Loader object with the unique request ID for the corresponding network request;
each URL Loader object receiving the response associated with its respective network request and inserting the request ID in the response associated with the respective network request prior to the response being routed to the one or more application event listeners.

14. The system of claim 8, wherein each network request of the plurality of network requests and corresponding response has an application type code;
wherein each response of the plurality of responses is routed to the application event listeners based on the application type code; and
wherein at least some of the responses of the plurality of responses have the same application type code.

15. A non-transitory computer-accessible storage medium storing program instructions computer-executable to implement:
the client-side component receiving, from client code, a plurality of network requests each corresponding to a respective unique response function in the client code, and in response, creating a respective application event listener for each network request of the plurality of network requests;
the client-side component assigning a unique request ID to each of the plurality of network requests and to the corresponding application event listener for each request, wherein the plurality of network requests are forwarded to a network server;
the client-side component receiving a plurality of responses corresponding to the network requests, wherein the plurality of responses are not guaranteed to be received in a same order that the plurality of network requests were sent; and
in response to receiving the plurality of responses, the client-side component routing each response of the plurality of responses to one or more of the plurality of application event listeners, wherein for each response one or more of the plurality of application event listeners performs a comparison between a request ID for the response and the unique request ID associated with the application event listener, wherein if the comparison results in a match, the application event listener sends the response to the respective response function in the client code corresponding to the application event listener.

16. The non-transitory computer-accessible storage medium of claim 15, wherein the client-side component and the client code are hosted by a network-enabled application.

17. The non-transitory computer-accessible storage medium of claim 16, wherein said network-enabled application comprises a web browser.

18. The non-transitory computer-accessible storage medium of claim 17, wherein said client-side component comprises a browser plug-in.

19. The non-transitory computer-accessible storage medium of claim 15, wherein said network request comprises a hypertext transfer protocol (HTTP) request.

20. The non-transitory computer-accessible storage medium of claim 15, wherein the program instructions are further executable to implement:
the client-side component creating a separate URL Loader object for each network request;
the client-side component associating each respective URL Loader object with the unique request ID for the corresponding network request;
each URL Loader object receiving the response associated with its respective network request and inserting the request ID in the response associated with the respective network request prior to the response being routed to the one or more application event listeners.

21. The non-transitory computer-accessible storage medium of claim 15, wherein each network request of the plurality of network requests and corresponding response has an application type code;
wherein each response of the plurality of responses is routed to the application event listeners based on the application type code; and
wherein at least some of the responses of the plurality of responses have the same application type code.
